(19) United States
(12) Patent Application Publication
(10) Pub. No.: US 2014/0333105 A1
(43) Pub. Date: Nov. 13, 2014

(54) SAFETY SEAT FOR PREGNANT MOTHER

(71) Applicant: Maxwell Opoku AGYEMANG, South Miami, FL (US)

(72) Inventor: Maxwell Opoku AGYEMANG, South Miami, FL (US)

(21) Appl. No.: 14/266,417

(22) Filed: Apr. 30, 2014

Related U.S. Application Data
(63) Continuation-in-part of application No. 13/893,289, filed on May 13, 2013, now abandoned.

(51) Int. Cl. B60N 2/24; B60R 22/00

(52) U.S. Cl. CPC B60N 2/24; B60R 22/00
USPC 297/256.15

(57) ABSTRACT

A passenger seat and safety belt system in accordance with the principles of the invention provides a comfortable seat having two straps that adjustably and safely restrain the passenger. A restraining mechanism, for example a buckle, may cross over the chest just above the nipple line connecting the two straps. This may provide a comfortable seat for the mother and safe protection for both her and the fetus. The seat may include an attaching mechanism that securely fastens it to the seatbelts of a vehicle.

### CROSS-REFERENCE TO RELATED APPLICATIONS

This application is a continuation-in-part to U.S. Utility application Ser. No. 13/893,289 filed May 13, 2013 and claims priority thereto.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable.

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### BACKGROUND OF THE INVENTION

1. Field of Endeavor

The present invention relates to systems, devices and methods of safety belts for use during transportation. More particularly, the invention relates to a safety belt for protecting a pregnant women while simultaneously protecting her unborn child in the event of an accident.

2. Background Information

There have been numerous attempts in the prior art to design a seatbelt apparatus specifically designed for use by a pregnant person so as to avoid exerting a sudden force on the womb in the event of an accident. Most of these seatbelt assemblies in the prior art are rather complex and are designed to replace the existing seatbelt apparatus in the car, thereby becoming a permanent installation. Additionally, many of the seatbelt assemblies for pregnant persons existing in the prior art are extremely cumbersome and require a great deal of effort to secure the assembly in a fastened position about the user's body.

Individuals should always wear a seatbelt, even while pregnant. However, wearing a lap belt across one's pregnant stomach can be dangerous. In the event of an accident, the lap belt could potentially cause severe harm to the unborn child. The belt is often positioned directly over the top of the baby, and in a collision can cause trauma to the child, including spontaneous abortion, placenta abruption and death is even a possibility depending on the severity of the accident and the position of the lap belt. Pregnant women are often uncomfortable with the idea of not wearing a seatbelt, but also want to protect their child from seatbelt trauma. A more efficient seatbelt option is needed.

In view of the foregoing, there is a need to provide a safety belt for pregnant women that is comfortable, effective and will not harm an unborn child.

### BRIEF SUMMARY OF THE INVENTION

Accordingly, the primary object of the present invention is to provide a seat for improved safety for a pregnant woman her unborn child during travel. The seat may be placed onto a car, train or airplane seat, and can be removed when necessary.

In greater detail, a passenger seat and safety belt system in accordance with the principles of the invention provides a comfortable seat having two straps that adjustably and safely restrain the passenger. A restraining mechanism, for example a buckle, may cross over the chest just above the nipple line connecting the two straps. This may provide a comfortable seat for the mother and safe protection for both her and the fetus. The seat may include an attaching mechanism that securely fastens it to the seatbelts of a vehicle. The passenger seat of the invention may be manufactured to accommodate pregnant adult female. of any body mass index.

It is therefore an object of the present invention to provide a passenger seat having a safety belt system for an airplane, car, boat, train or other transportation vehicle capable of providing rigid safety for both a pregnant mother and an unborn child during travel. In the case of a pregnant mother, this seat may be mounted onto the airplane's seats.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front view of a passenger seat in accordance with the principles of the invention;

FIG. 2 is a side view of a passenger seat in accordance with the principles of the invention;

FIG. 3 is a perspective view of a passenger seat in accordance with the principles of the invention;

FIG. 4 is an environmental perspective view of a passenger seat in accordance with the principles of the invention;

FIG. 5 is an environmental perspective view of a passenger seat in accordance with the principles of the invention.

### DETAILED DESCRIPTION

Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

Disclosed is a passenger seat having a safety belt system for an airplane, car, boat, train or other transportation vehicle capable of providing rigid safety for both a pregnant mother and an unborn child during travel. In the case of a pregnant mother, this seat may be mounted onto a vehicle's seats, and can be disengaged when desired.

In greater detail, a passenger seat and safety belt system in accordance with the principles of the invention provides a comfortable seat having two straps that adjustably and safely restrain the passenger. A restraining mechanism, for example a buckle, may cross over the chest just above the nipple line connecting the two straps. This may provide a comfortable seat for the mother and safe protection for both her and the fetus. The safety belt system on the passenger seat is designed to safely restrain a pregnant woman. The seat may include an attaching mechanism that securely fastens it to the seatbelts of a vehicle. The passenger seat of the invention may be manufactured to accommodate pregnant adult female. of any body mass index. In the descriptions below, a safety seat in accordance with the principles of the invention is generally referred to as a “passenger seat.” However, the safety seat may be a driver's seat, a pilot's seat or any other seat which may require the use of restraints on a person occupying the seat.

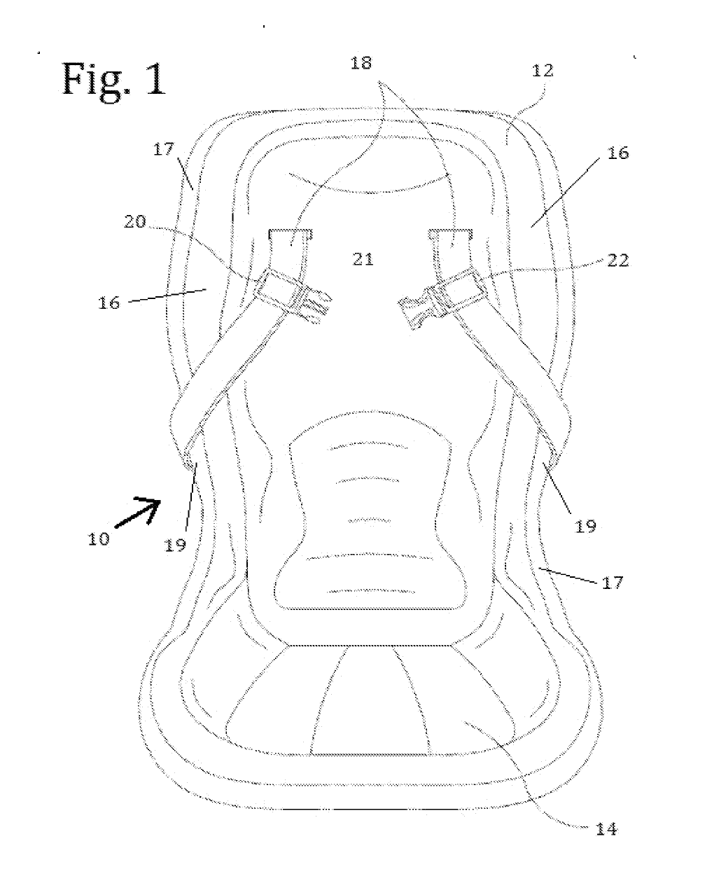

FIG. 1 shows a passenger seat 10 in accordance with the principles of the invention. Passenger seat 10 may include a back 12, a bottom 14 and two sidewalls 16. The bottom 14 may optionally include padding to increase comfort. Similarly, the back 12 may also include padding. The back 12, bottom 14 and sidewalls 16 may be comprised of a substantially rigid material such as for example, plastics. Optionally, the components of the passenger seat 10 may be comprised of more rigid or less rigid materials, including metals, wood, polymers, carbon fiber, or other suitable materials.

Two straps 18 may protrude from the front of the back 12 through slots 21 and extend around sidewalls 16. The straps 18 may include slidably adjustable restraining mechanisms 20 and 22. In this embodiment, restraining mechanisms 20 and 22 comprise a buckle. However, other suitable methods for removably attaching the straps 18 securely to each other, for example laces, snaps, buttons and the like may be used. Mechanisms 20 and 22 may comprise an interlocking male buckle 20 and female buckle 22. Both mechanisms may be capable of slidably traversing the length of straps 18 to maximize comfort for an occupant of the seat 10. Straps 18 may be adjusted to optimally fit a passenger. Restraining mechanisms 20 and 22 conjunction with the straps 18 provide a safety belt system capable of securely holding a passenger in the passenger seat 10.

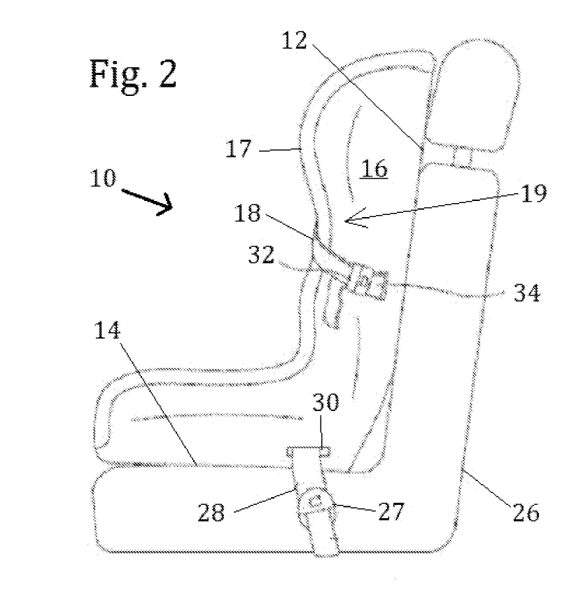

FIG. 2 shows a passenger seat 10 in accordance with the principles of the invention, removably affixed to a vehicle seat 26. Vehicle seat 26 may be a seat in an airplane, boat, truck, bus, van, car, train or other vehicle. Strap 18 protrudes from the exterior side of side wall 16 from slots 34. Strap 18 may include an adjustment buckle 32 that allows the length of the strap 18 to be adjusted in order to accommodate passengers of different size. Strap 18 protrudes from the exterior of sidewall 16 such that strap 18 extends over the lip 17 of sidewall 16. The lip 17 of sidewall 16 may include a concave region 19 into which strap 18 will naturally fall into when the restraining mechanisms 20 and 22 are engaged such that tension is applied to strap 18. In this manner, the general positioning of strap 18 may be accomplished. As may be seen, sidewall 16 may extend outwardly from the entire length of both the back 12 and the bottom 14 to provide protection on each side of an occupant of the seat. This may offer additional protection to a passenger. Optionally, the side wall may only extend from a portion of the back or the bottom sufficient to hold the straps 18 away from the sides of the occupant.

Belt 28 may be the seatbelt of the vehicle seat 26, having an adjustable buckle 27. Belt 28 may pass through slots 30, located in the seat of the and connect to buckle 27 in much the same way as child seats and automobiles commonly do. Other suitable mechanisms may be used to attach the passenger seat 10 designed in accordance with the principles of the invention to vehicle seat 26.

Instead of utilizing a concave region on the lip of the sidewall to position the strap, the safety seat may include an indention on the lip of the sidewall, or a slot within the sidewall to properly position the strap.

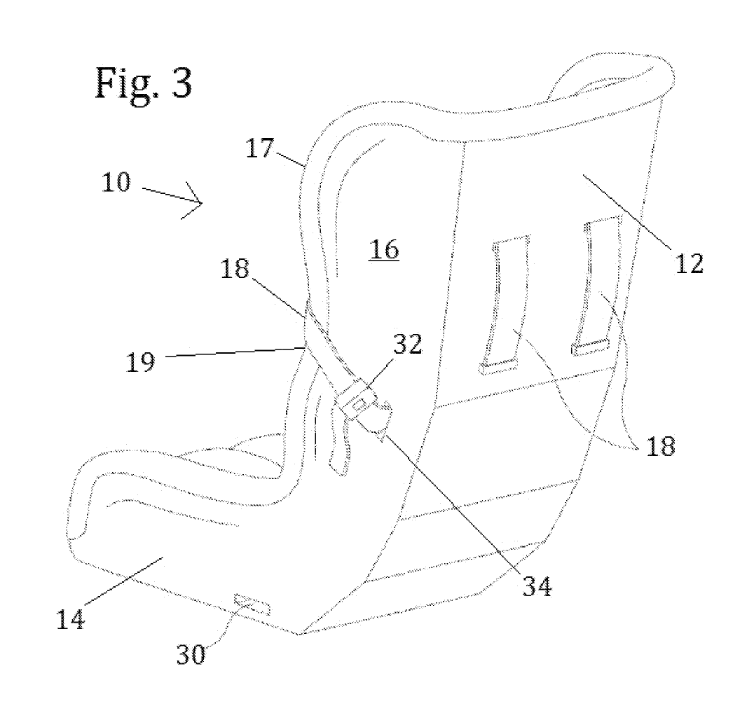

FIG. 3 shows the passenger seat 10 designed in accordance with the principles of the invention disengaged from the vehicle seat 26. Seatbelt 28 no longer protrudes from slots 30. Also may be seen are straps 18 extending across a portion of the rear side of the back 12. Optionally, these portions of the straps 18 may be used to engage seatbelts on the back of a vehicle seat onto which passenger seat 10 is placed. For example, automobiles commonly include a diagonal seatbelt intended to cross over the torso of a passenger. Such a seatbelt may be placed through straps 18 on the back 12 of the passenger seat 10. As may be seen, seatbelt 18 may be naturally drawn into concave region 19 of the lip 17 of the sidewall.

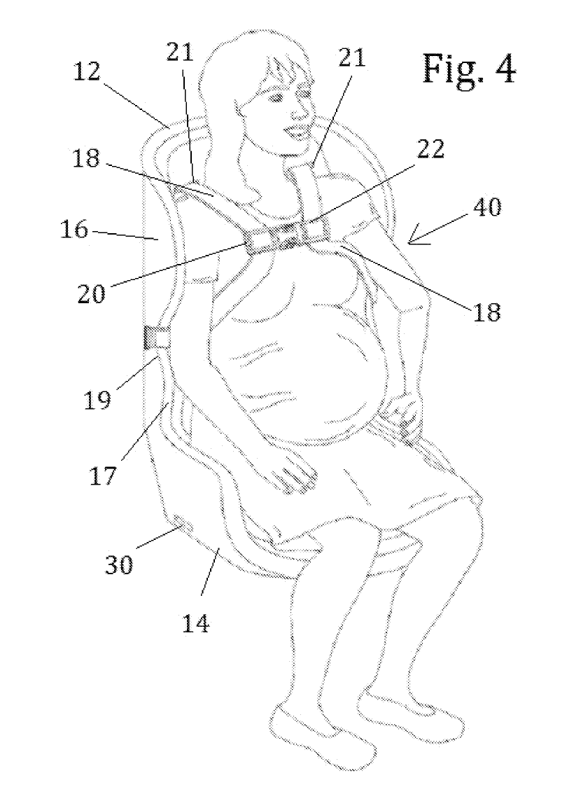

FIG. 4 shows the passenger seat 10 in accordance with principles of the invention having a pregnant passenger 40 seated in it. As may be seen, straps 18 naturally fall into the concave region 19 of the sidewalls 16. Restraining mechanisms 20 and 22, while adjustable and capable of traversing the lengths of straps 18, may be generally positioned above the passengers breasts in order avoid discomfort. The concave region 19 of the passenger seat 10 may be located at the approximate middle of an occupant's torso, in approximately the same region as the diaphragm. Straps 18 are pulled outward by the presence of sidewall 16. As a result, tightening the straps 18 may not result in uncomfortable and/or excessive tightening and restriction of the sides of the occupant's 40 torso. That is, strap 18 extends from the concave region 19 of sidewall 16 toward the restraining mechanisms 20 and 22. Were straps 18 attached directly to the back 12 of the seat 10, tightening of the straps 18 would squeeze an occupant's torso from all directions. Passenger seat 10, on the other hand, may allow straps 18 to be pulled very tight, having very high tension and therefore holding an occupant more firmly in place without unduly constricting the passengers body. Sidewalls 16 extend outward from back 12 an amount sufficient to hold straps 18 away from the sides of the passenger 40 to prevent discomfort. In addition, the placement of concave regions 19 substantially above the position of the stomach prevent straps 18 from constricting about the stomach of a pregnant passenger.

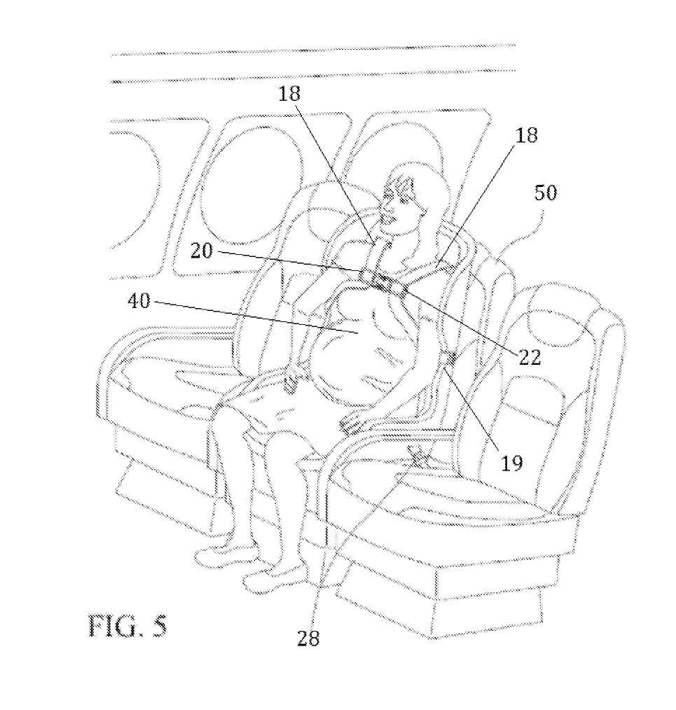

FIG. 5 shows the passenger seat 10 in accordance with the principles of the invention, removably attached to a vehicle seat 50 located in an airplane. In use, passenger seat 10 may be easily engaged with an airplane or other vehicle seat. Mechanisms 20 and 22 may be engaged to each other and straps 18 may be adjusted to a very high tension. When straps 18 are tightened, they naturally fall in place into concave region 19 of the sidewall 16. Restraining mechanisms 20 and 22 may be adjusted such that they are above the passenger's breasts. Airplane seatbelt 28 may be drawn through the slots 30 of the seat 10 in order to secure it to the vehicle seat 50.

Whereas, the present invention has been described in relation to the drawings attached hereto, it should be understood that other and further modifications, apart from those shown or suggested herein, may be made within the spirit and scope of this invention. Descriptions of the embodiments shown in the drawings should not be construed as limiting or defining the ordinary and plain meanings of the terms of the claims unless such is explicitly indicated.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

This design also provides the basis of an overall better traveling seatbelt than currently used which has been documented to be associated with hemiplegia and quadriplegia in cases of high speed accidents.

1. A safety seat comprising:
a back having a front and a rear;
a bottom;
two sidewalls, each having an exterior side and a lip, each lip having a concave region;
two straps, each protruding from a slot in the front of the back and extending around one of the sidewalls, over the lip of the sidewall and into a slot on the exterior of the sidewall; and,
two slidably adjustable restraining mechanisms capable of slidably traversing the length of the straps;
wherein each sidewall is capable of holding the straps away from the sides of an occupant of the safety seat.

2. The safety seat of claim 1 wherein the sidewalls extend outward along the entire length of the back and bottom of the safety seat.

3. The safety seat of claim 1 wherein the sidewalls only extend outward from a portion of the safety seat sufficient to hold the straps away from the sides of the occupant.

4. The safety seat of claim 1 wherein the straps naturally fall into the concave regions of the lips when tension is applied to them.

5. The safety seat of claim 1 wherein the two slidably adjustable restraining mechanisms comprise an interlocking male buckle and female buckle.

6. The safety seat of claim 1 further comprising slots in the bottom of the safety seat capable of accommodating a seatbelt of a vehicle seat.

7. The safety seat of claim 1 wherein a portion of each of the straps extends across a portion of the rear of the back and is capable of engaging seatbelts on the back of a vehicle seat.

8. The safety seat of claim 1 wherein the concave region of each of the lips of each of the sidewalls is located approximately at the middle of an occupant's torso.

9. The safety seat of claim 1 wherein the straps each have an adjustment buckle capable of adjusting the lengths of each of the straps.

10. A safety seat comprising:
a back having a front and a rear;
a bottom;
two sidewalls, each having an exterior side and a lip, each lip having a concave region;
two straps, each protruding from a slot in the front of the back and extending around one of the sidewalls, over the lip of the sidewall and into a slot on the exterior of the sidewall; and,
two slidably adjustable restraining mechanisms capable of slidably traversing the length of the straps wherein each sidewall is capable of holding the straps away from the sides of an occupant of the safety seat; and,
wherein the straps naturally fall into the concave regions of the lips when tension is applied to them.

11. The safety seat of claim 10 wherein the two slidably adjustable restraining mechanisms comprise an interlocking male buckle and female buckle.

12. The safety seat of claim 11 further comprising slots in the bottom of the safety seat capable of accommodating a seatbelt of a vehicle seat.

13. The safety seat of claim 12 wherein the concave region of each of the lips of each of the sidewalls is located approximately at the middle of an occupant's torso.

14. The safety seat of claim 13 wherein the straps each have an adjustment buckle capable of adjusting the lengths of each of the straps.

15. The safety seat of claim 14 wherein a portion of each of the straps extends across a portion of the rear of the back and is capable of engaging seatbelts on the back of a vehicle seat.

16. The safety seat of claim 15 wherein the sidewalls extend outward along the entire length of the back and bottom of the safety seat.

17. The safety seat of claim 15 wherein the sidewalls only extend outward from a portion of the safety seat sufficient to hold the straps away from the sides of the occupant.

18. A safety seat comprising:
a back having a front and a rear;
a bottom;
two sidewalls, each having an exterior side and a lip;
two straps, each protruding from a slot in the front of the back and extending around one of the sidewalls and into a slot on the exterior of the sidewall; and,
two slidably adjustable restraining mechanisms capable of slidably traversing the length of the straps;
wherein each sidewall is capable of holding the straps away from the sides of an occupant of the safety seat.

19. The safety seat of claim 18 further comprising an indention in the lip of the sidewall through which the strap extends.
